(19) United States
(12) Patent Application Publication
(10) Pub. No.: US 2024/0080777 A1
(43) Pub. Date: Mar. 7, 2024

(54) SYSTEMS AND METHODS FOR ADJUSTING SIGNAL TRANSMISSION CHARACTERISTIC FOR AN ELECTRONIC DEVICE

(71) Applicant: Apple Inc., Cupertino, CA (US)

(72) Inventors: Dhruv Khati, San Jose, CA (US); Sanjeevi Balasubramanian, San Jose, CA (US); Anjaneyulu Maganti, San Jose, CA (US); Shiva Krishna Narra, San Jose, CA (US); Krishna Myneni, Santa Clara, CA (US)

(21) Appl. No.: 17/902,548

(22) Filed: Sep. 2, 2022

(51) Int. Cl. H04W 52/24; H04L 1/00; H04W 52/48

(52) U.S. Cl. CPC H04W 52/248; H04L 1/0002; H04W 52/48; H04W 16/28

(57) ABSTRACT

An electronic device includes a transmitter and processing circuitry communicatively coupled to the transmitter. The processing circuitry is configured to transmit a first signal directed to a communication node, determine unsuccessful receipt of the first signal by the communication node, and transmit a second signal to the communication node at a transmission power that is increased based on a trend of an elevation angle of the communication node with respect to the electronic device and based on the unsuccessful receipt of the first signal by the communication node.

### BACKGROUND

The present disclosure relates generally to wireless communication and more specifically to adjusting signal transmission, such as for signals that include data.

A mobile communication device (e.g., user equipment) may communicate signals (e.g., signals that include data) via a communication node, such as a non-terrestrial station, a satellite, and/or a high altitude platform station. For instance, the mobile communication device may transmit a signal to the communication node, and the communication node may forward the signal to a destination device. It is now recognized that operation of the mobile communication device to transmit a signal to the communication node may be improved. For example, the mobile communication device and the communication node may move relative to one another. Relative movement between the mobile communication device and the communication node may reduce a line of sight between the mobile communication device and the communication node, thereby reducing potential for successful receipt of a signal transmitted by the mobile communication device directed to the communication node. As a result, an intended recipient may not receive the signal transmitted by the mobile communication device.

### SUMMARY

In one embodiment, an electronic device includes a transmitter and processing circuitry communicatively coupled to the transmitter and configured to transmit a first signal directed to a communication node at a transmission power using the transmitter and transmit a second signal directed to the communication node at an increased transmission power using the transmitter based on a trend of a position of the communication node and based on unsuccessful receipt of the first signal by the communication node.

In another embodiment, a non-transitory computer-readable medium includes instructions that, when executed by processing circuitry, are configured to cause the processing circuitry to transmit a first signal directed to a communication node at a first transmission power using a transmitter of an electronic device, establish a communication link with the communication node based on successful receipt of the first signal, and transmit a second signal directed to the communication node at a second transmission power using the transmitter based on unsuccessful receipt of the first signal by the communication node. The second transmission power is based on a trend of an elevation angle of the communication node with respect to the electronic device.

In yet another embodiment, a method includes determining, via processing circuitry of an electronic device, a first indication of a priority of a signal, a second indication of a communication quality between the electronic device and a communication node, and a third indication of an elevation angle of the communication node, and transmitting, via the processing circuitry, the signal directed to the communication node at a rate using a transmitter of the electronic device based on the first indication, the second indication, and the third indication.

### BRIEF DESCRIPTION OF THE DRAWINGS

Various aspects of this disclosure may be better understood upon reading the following detailed description and upon reference to the drawings described below in which like numerals refer to like parts.

FIG. 1 is a block diagram of an electronic device, according to embodiments of the present disclosure;

FIG. 2 is a functional diagram of the electronic device of FIG. 1, according to embodiments of the present disclosure;

FIG. 3 is a schematic diagram of a communication system including the electronic device of FIG. 1, according to embodiments of the present disclosure;

FIG. 4 is a flowchart of a method for adjusting transmission power to re-transmit a signal via the electronic device of FIG. 1, according to embodiments of the present disclosure;

FIG. 5 is a flowchart of a method for transmitting a signal at a transmission power via the electronic device of FIG. 1 based on an elevation angle trend, according to embodiments of the present disclosure;

FIG. 6 is a flowchart of a method for adjusting signal transmission via the electronic device of FIG. 1 based on an elevation angle trend, according to embodiments of the present disclosure;

FIG. 7 is a flowchart of a method for adjusting operation to enable signal transmission via the electronic device of FIG. 1 to perform an abbreviated data transmission operation, according to embodiments of the present disclosure;

FIG. 8 is a flowchart of a method for adjusting a rate of transmission of a signal via the electronic device of FIG. 1 based on priority, communication quality, and elevation angle, according to embodiments of the present disclosure; and

FIG. 9 is a flowchart of a method for adjusting a transmission characteristic of a signal via the electronic device of FIG. 1 based on orientation of the electronic device, an error rate of data transmission, and a type of a communication node, according to embodiments of the present disclosure.

### DETAILED DESCRIPTION OF SPECIFIC EMBODIMENTS

This disclosure is directed to adjusting signal transmission via a mobile communication device. The mobile communication device may initially transmit a signal to a communication node, and the communication node may forward the signal received from the mobile communication device to a destination device (e.g., a communication hub, another mobile communication device). For example, the signal may include or be associated with one of various forms of communication, such as emergency text messaging, emergency voice calling, acknowledgement messaging, video streaming, Internet browsing, and so forth.

In existing approaches, the mobile communication device may transmit and/or re-transmit signals using the same or substantially the same transmission characteristic, such as the same transmission power and/or the same rate of transmission. That is, at a first instance or period of time, the mobile communication device may transmit a signal directed to the communication node using a particular transmission characteristic. At a second instance or period of time, the mobile communication device may transmit another signal directed to the communication node using the same particular transmission characteristic. However, transmitting each signal using the same transmission characteristic at different times may not enable desirable operation of the electronic device for successful receipt of a signal at the communication node. As an example, the potential for successful receipt of a signal at the communication node may be different during the first instance as compared to during the second instance. Therefore, transmitting the signal using the same transmission characteristic for the different instances may not enable the communication node to receive the signal and/or may cause the mobile communication device to consume an undesirable (e.g., excessive) amount of resources during operation to transmit the signal.

Embodiments herein provide various apparatuses and techniques to adjust the transmission characteristic used by the mobile communication device to transmit a signal to the communication node for subsequent transmission to a destination device. In some embodiments, the mobile communication device may determine a relative positioning between the mobile communication device and the communication node and adjust a transmission power based on the relative positioning. For instance, the relative positioning may include a trend of an elevation angle of the communication node relative to the mobile communication device, such as whether the elevation angle is increasing or decreasing over time. An increasing elevation angle may improve a line of sight between the mobile communication device and the communication node to increase potential receipt of a signal at the communication node, whereas a decreasing elevation angle may reduce the line of sight and reduce potential receipt of the signal at the communication node. Thus, re-transmission of a signal based on the trend of the elevation angle may cause the mobile communication device to operate more suitably based on the changing potential receipt of the signal. As an example, in response to determining the elevation angle is decreasing, the mobile communication device may increase the transmission power by a higher value at which a subsequent signal is transmitted to compensate for the possible decrease in potential receipt of the signal. In response to determining the elevation angle is increasing, the mobile communication device may increase the transmission power by a lower value to limit expenditure of resources (e.g., power consumption, transmission power budget usage) associated with transmitting the signal, while facilitating receipt of the signal by the communication node.

In additional or alternative embodiments, the mobile communication device may determine other parameters and adjust a rate of signal transmission based on the other parameters. For example, the other parameters may include a priority of the signal (e.g., of data included in the signal), a communication quality between the mobile communication device and the communication node, and/or the elevation angle of the communication node. For instance, in response to a determination that the signal is of high priority, the communication quality is high, and/or the elevation angle is high to indicate a relatively higher desire and/or a relatively higher potential for signal receipt at the communication node, the mobile communication device may transmit the signal at a higher rate. In response to a determination that the signal is of lower priority, the communication quality is lower, and/or the elevation angle is lower, the mobile communication device may transmit the signal at a lower rate. In response to a determination that the signal is of lower priority, the communication quality is intermediate, and/or the elevation angle is intermediate, the mobile communication device may transmit the signal at an intermediate rate. As such, the mobile communication device may transmit the signal at a more suitable rate based on determined parameters. Indeed, adjusting different transmission characteristics of a signal based on various parameters may enable more suitable and/or desirable operation of the mobile communication device and corresponding expenditure of resources to transmit signals.

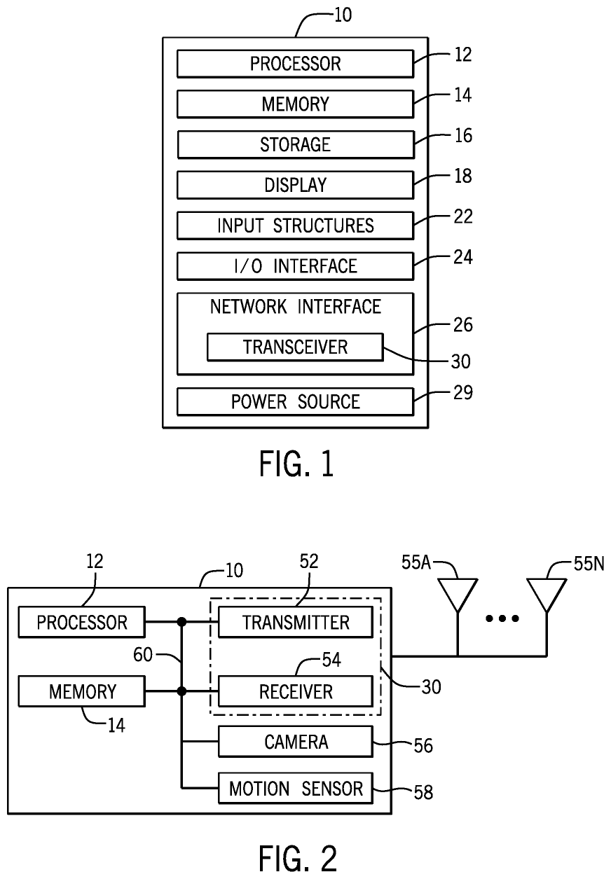

With the preceding in mind, FIG. 1 is a block diagram of an electronic device, user equipment, or mobile communication device 10, according to embodiments of the present disclosure. The electronic device 10 may include, among other things, one or more processors 12 (collectively referred to herein as a single processor for convenience, which may be implemented in any suitable form of processing circuitry), memory 14, nonvolatile storage 16, a display 18, input structures 22, an input/output (I/O) interface 24, a network interface 26, and a power source 29. The various functional blocks shown in FIG. 1 may include hardware elements (including circuitry), software elements (including machine-executable instructions) or a combination of both hardware and software elements (which may be referred to as logic). The processor 12, the memory 14, the nonvolatile storage 16, the display 18, the input structures 22, the input/output (I/O) interface 24, the network interface 26, and/or the power source 29 may each be communicatively coupled directly or indirectly (e.g., through or via another component, a communication bus, a network) to one another to transmit and/or receive signals between one another. It should be noted that FIG. 1 is merely one example of a particular implementation and is intended to illustrate the types of components that may be present in electronic device 10.

By way of example, the electronic device 10 may include any suitable computing device, including a desktop or notebook computer (e.g., in the form of a MacBook®, MacBook® Pro, MacBook Air®, iMac®, Mac® mini, or Mac Pro® available from Apple Inc. of Cupertino, California), a portable electronic or handheld electronic device such as a wireless electronic device or smartphone (e.g., in the form of a model of an iPhone® available from Apple Inc. of Cupertino, California), a tablet (e.g., in the form of a model of an iPad® available from Apple Inc. of Cupertino, California), a wearable electronic device (e.g., in the form of an Apple Watch® by Apple Inc. of Cupertino, California), and other similar devices. It should be noted that the processor 12 and other related items in FIG. 1 may be generally referred to herein as “data processing circuitry.” Such data processing circuitry may be embodied wholly or in part as software, hardware, or both. Furthermore, the processor 12 and other related items in FIG. 1 may be a single contained processing module or may be incorporated wholly or partially within any of the other elements within the electronic device 10. The processor 12 may be implemented with any combination of general-purpose microprocessors, microcontrollers, digital signal processors (DSPs), field programmable gate array (FPGAs), programmable logic devices (PLDs), controllers, state machines, gated logic, discrete hardware components, dedicated hardware finite state machines, or any other suitable entities that may perform calculations or other manipulations of information. The processors 12 may perform the various functions described herein.

In the electronic device 10 of FIG. 1, the processor 12 may be operably coupled with a memory 14 and a nonvolatile storage 16 to perform various algorithms. Such programs or instructions executed by the processor 12 may be stored in any suitable article of manufacture that includes one or more tangible, computer-readable media. The tangible, computer-readable media may include the memory 14 and/or the nonvolatile storage 16, individually or collectively, to store the instructions or routines. The memory 14 and the nonvolatile storage 16 may include any suitable articles of manufacture for storing data and executable instructions, such as random-access memory, read-only memory, rewritable flash memory, hard drives, and optical discs. In addition, programs (e.g., an operating system) encoded on such a computer program product may also include instructions that may be executed by the processor 12 to enable the electronic device 10 to provide various functionalities.

In certain embodiments, the display 18 may facilitate users to view images generated on the electronic device 10. In some embodiments, the display 18 may include a touch screen, which may facilitate user interaction with a user interface of the electronic device 10. Furthermore, it should be appreciated that, in some embodiments, the display 18 may include one or more liquid crystal displays (LCDs), light-emitting diode (LED) displays, organic light-emitting diode (OLED) displays, active-matrix organic light-emitting diode (AMOLED) displays, or some combination of these and/or other display technologies.

The input structures 22 of the electronic device 10 may enable a user to interact with the electronic device 10 (e.g., pressing a button to increase or decrease a volume level). The I/O interface 24 may enable electronic device 10 to interface with various other electronic devices, as may the network interface 26. In some embodiments, the I/O interface 24 may include an I/O port for a hardwired connection for charging and/or content manipulation using a standard connector and protocol, such as the Lightning connector provided by Apple Inc. of Cupertino, California, a universal serial bus (USB), or other similar connector and protocol.

The network interface 26 may include, for example, one or more interfaces for a satellite connection (e.g., via a satellite network), a peer-to-peer connection, a personal area network (PAN), such as an ultra-wideband (UWB) or a BLUETOOTH® network, for a local area network (LAN) or wireless local area network (WLAN), such as a network employing one of the IEEE 802.11x family of protocols (e.g., WI-FI®), and/or for a wide area network (WAN), such as any standards related to the Third Generation Partnership Project (3GPP), including, for example, a 3^{rd} generation (3G) cellular network, universal mobile telecommunication system (UMTS), 4^{th} generation (4G) cellular network, long term evolution (LTE®) cellular network, long term evolution license assisted access (LTE-LAA) cellular network, 5^{th} generation (5G) cellular network, New Radio (NR) cellular network, 6^{th} generation (6G) cellular network and beyond, and so on. In particular, the network interface 26 may include, for example, one or more interfaces for using a Release-15 cellular communication standard of the 5G specifications that include the millimeter wave (mmWave) frequency range (e.g., 24.25-300 gigahertz (GHz)). The network interface 26 of the electronic device 10 may allow communication over the aforementioned networks (e.g., 5G, Wi-Fi, LTE-LAA, and so forth). The network interface 26 may also include one or more interfaces for, for example, broadband fixed wireless access networks (e.g., WIMAX®), mobile broadband Wireless networks (mobile WIMAX®), asynchronous digital subscriber lines (e.g., ADSL, VDSL), digital video broadcasting-terrestrial (DVB-T®) network and its extension DVB Handheld (DVB-H®) network, UWB network, alternating current (AC) power lines, and so forth. The network interface 26 may, for instance, include a transceiver 30 for communicating signals using one of the aforementioned networks. The power source 29 of the electronic device 10 may include any suitable source of power, such as a rechargeable lithium polymer (Li-poly) battery and/or an alternating current (AC) power converter.

FIG. 2 is a functional diagram of the electronic device 10 of FIG. 1, according to embodiments of the present disclosure. As illustrated, the processor 12, the memory 14, the transceiver 30, a transmitter 52, a receiver 54, and/or antennas 55 (illustrated as 55A-55N, collectively referred to as an antenna 55) may be communicatively coupled directly or indirectly (e.g., through or via another component, a communication bus, a network) to one another to transmit and/or receive signals between one another.

The electronic device 10 may include the transmitter 52 and/or the receiver 54 that respectively transmit and receive signals between the electronic device 10 and an external device via, for example, a network (e.g., including base stations) or a direct connection. As illustrated, the transmitter 52 and the receiver 54 may be combined into the transceiver 30. The electronic device 10 may also have one or more antennas 55A-55N electrically coupled to the transceiver 30. The antennas 55A-55N may be configured in an omnidirectional or directional configuration, in a single-beam, dual-beam, or multi-beam arrangement, and so on. Each antenna 55 may be associated with a one or more beams and various configurations. In some embodiments, multiple antennas of the antennas 55A-55N of an antenna group or module may be communicatively coupled a respective transceiver 30 and each emit radio frequency signals that may constructively and/or destructively combine to form a beam. The electronic device 10 may include multiple transmitters, multiple receivers, multiple transceivers, and/or multiple antennas as suitable for various communication standards. For example, the electronic device 10 may include a first transceiver to send and receive messages using a first wireless communication network, a second transceiver to send and receive messages using a second wireless communication network, and a third transceiver to send and receive messages using a third wireless communication network, though any or all of these transceivers may be combined in a single transceiver. In some embodiments, the transmitter 52 and the receiver 54 may transmit and receive information via other wired or wireline systems or means.

The electronic device 10 may also include one or more cameras or image or light sensors (e.g., as part of the input structures 22). The one or more cameras or image or light sensors (collectively referred to as “a camera 56” herein) may capture images and/or determine amounts of light surrounding the electronic device 10. In some embodiments, the camera 56 may include a front-facing camera (e.g., disposed on a display surface of the electronic device 10 having the display 18) and/or a rear-facing camera (e.g., disposed on a base or back surface, opposite the display surface, of the electronic device 10).

The electronic device 10 may include one or more motion sensors 58 (e.g., as part of the input structures 22). The one or more motion sensors (collectively referred to as “a motion sensor 58” herein) may include an accelerometer, gyroscope, gyrometer, and the like, that detect and/or facilitate determining an orientation (e.g., including pitch, yaw, roll, and so on) and/or motion of the electronic device 10.

As illustrated, the various components of the electronic device 10 may be coupled together by a bus system 60. The bus system 60 may include a data bus, for example, as well as a power bus, a control signal bus, and a status signal bus, in addition to the data bus. The components of the electronic device 10 may be coupled together or accept or provide inputs to each other using some other mechanism.

As discussed above, the electronic device 10 may transmit a signal directed to a communication node for subsequent transmission to a recipient. Embodiments herein provide various apparatuses and techniques to adjusting a transmission characteristic based on different determined parameters. As an example, the electronic device 10 may adjust (e.g., increase) a transmission power used to re-transmit the signal based on an elevation angle of the communication node relative to the electronic device 10. As another example, the electronic device 10 may adjust a rate of signal transmission based on priority of the signal, communication quality between the electronic device 10 and the communication node, and/or the elevation angle of the communication node. Adjusting the transmission power and/or the rate of signal transmission based on various parameters may enable the electronic device 10 to transmit and/or re-transmit a signal that increases a likelihood of successful receipt by the communication node. For example, a potential of successful receipt of the signal by the communication node may be increased, and/or a power consumption associated with transmitting a signal via the electronic device 10 may be reduced (e.g., due to decreasing the number of re-transmissions).

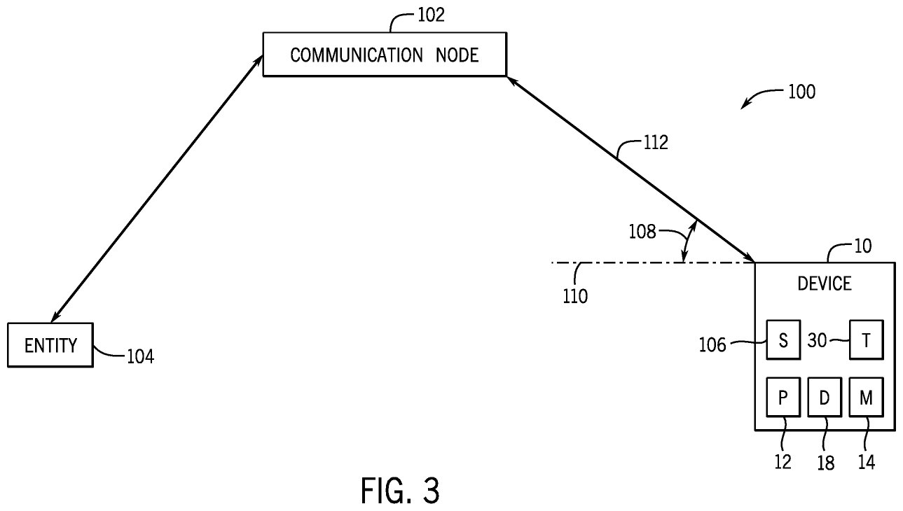

FIG. 3 is a schematic diagram of a communication system 100 including the electronic device 10, according to embodiments of the present disclosure. The communication system 100 includes a communication node 102, which may include any combination of non-terrestrial base stations, high altitude platform stations, airborne base stations, spaceborne base stations, and/or any other suitable nonstationary communication node, communicatively coupled to the electronic device 10, which may be implemented as user equipment. The communication node 102 may be communicatively coupled to an entity 104, such as another electronic device, a terrestrial base station, a ground station, a call center, and so forth, to enable communication of signals between the entity 104 and the electronic device 10. For example, the electronic device 10 may transmit, using the transceiver 30 (e.g., the transmitter 52), a signal to the communication node 102 to establish a communication link used for communicating with the entity 104. For instance, the electronic device 10 may transmit a signal to establish communicative coupling with a random-access channel (RACH) for data transmission (e.g., call set-up, burst data transmission, other uplink communication from the electronic device 10 to the communication node 102) with the communication node 102.

The electronic device 10 may also determine whether the communication node 102 successfully receives the signal transmitted by the electronic device 10. For example, the communication node 102 may transmit an acknowledgement signal directed to the electronic device 10 in response to receiving the signal from the electronic device 10. In response to receiving an acknowledgement signal from the communication node 102, such as via the transceiver 30 (e.g., the receiver 54), after (e.g., within a duration of time of) transmitting the signal to the communication node 102, the electronic device 10 may determine that the communication node 102 successfully receives the signal and that communication via the communication node 102 is successful. However, in response to determining that an acknowledgment signal from the communication node 102 was not received after (e.g., within the duration of time of) transmitting the signal to the communication node 102, the electronic device 10 may determine that the communication node 102 did not successfully receive the signal and that communication via the communication node 102 is not successful. As a result, the electronic device 10 may re-transmit the signal directed to the communication node 102 to attempt to communicate via the communication node 102. Indeed, the electronic device 10 may continually or repeatedly re-transmit the signal directed to the communication node 102 until an acknowledgement signal is received from the communication node 102 via the transceiver 30 to indicate successful receipt of the transmitted signal by the communication node 102. Excessive re-transmissions may be wasteful in terms of processing, network, and/or power resources for the electronic device 10.

The electronic device 10 may adjust various characteristics associated with transmitting and/or re-transmitting a signal to the communication node 102. For instance, the electronic device 10 may determine various parameters and transmit and/or re-transmit the signal based on the parameters, which may be determined via stored data (e.g., in the memory 14, in the storage 16) and/or data received via a sensor 106. Such data may include two-line element set (TLE) data and/or ephemeris data associated with positioning and/or movement of the communication node 102, signal power data, signal quality data, or any other suitable data that would affect a likelihood of successful receipt of the signal. Thus, the electronic device 10 may transmit the signal in a more suitable manner to facilitate receipt of the signal by the communication node 102. For instance, in response to determining the parameters indicate lower communication quality conditions in which the communication node 102 may not readily receive a signal (e.g., at a sufficient or threshold receive quality or power) from the electronic device 10, the electronic device 10 may adjust (e.g., increase) the transmission power and/or the transmission rate to facilitate receipt of the signal by the communication node 102, and/or to reduce resource expenditure (e.g., power consumption, transmission power budget usage permitted by a regulatory entity) used to transmit a signal that may have low potential of successful receipt by the communication node 102 (e.g., by decreasing the transmission power and/or the transmission rate). As such, operation of the electronic device 10 to communicate signals and/or a duration of time in which the electronic device 10 may actively operate (e.g., without having to obtain additional power, without having to suspend signal transmission operations) may be improved.

An example parameter may include an elevation angle 108 indicative of a relative positioning between the communication node 102 and the electronic device 10. The elevation angle 108 may include an angle spanning between a horizon 110 and a line of sight 112 between the communication node 102 and the electronic device 10. For example, the processor 12 may determine the elevation angle 108 based on a property associated with movement of the Earth (e.g., a gravitational property, an orbit of the Earth), a historical positioning of the communication node 102, a motion of the electronic device 10, and/or any other indication of relative movement of the communication node 102 and/or of the electronic device 10, such as via the stored data and/or received sensor data.

The elevation angle 108 may be indicative of a potential communication quality between the communication node 102 and the electronic device 10. For example, a greater elevation angle 108 (e.g., an angle closer to 90 degrees, such as between 80 and 90 degrees, between 70 and 90 degrees, between 60 and 90 degrees, between 45 and 90 degrees, between 30 and 90 degrees, and so on) may indicate potentially reduced obstruction or interference (e.g., by a building, by foliage, by signals transmitted via other devices) of the line of sight 112, and therefore indicate potentially improved communication quality. A smaller elevation angle 108 (e.g., an angle closer to 0 degrees, such as between 0 and 10 degrees, between 0 and 20 degrees, between 0 and 30 degrees, between 0 and 45 degrees, and so on) may indicate potentially increased obstruction of the line of sight 112 and therefore indicate potentially reduced communication quality. For this reason, the communication node 102 may more readily or capably receive a signal transmitted from the electronic device 10 while elevation angle 108 is greater.

The elevation angle 108 may also change over time. For instance, the communication node 102 and the electronic device 10 may move relative to one another (e.g., as a part of scheduled operation of the communication node 102, as caused by movement of a user possessing the electronic device 10). The relative movement between the communication node 102 and the electronic device 10 may adjust the elevation angle 108, and therefore the associated communication quality, between the communication node 102 and the electronic device 10. In some circumstances, the elevation angle 108 may alternate or cycle between increasing (e.g., at a rising edge) up to a peak angle and then decreasing (e.g., at a falling edge) to a low angle. Thus, subsequent values of the elevation angles 108 may be predicted or projected based on the trend of the elevation angle 108. In other words, a previous value (e.g., a most recent value) of the elevation angle 108 may indicate a future value (e.g., an upcoming value) of the elevation angle 108.

Therefore, the electronic device 10 may determine the movement of the communication node 102 and/or of the electronic device 10 to adjust communication of signals. As an example, after determining that a signal transmitted by the electronic device 10 at an initial transmission power is not successfully received by the communication node, the electronic device 10 may adjust the transmission power used to re-transmit a subsequent signal based on the movement of the communication node 102. For instance, in response to determining that the elevation angle 108 is increasing over time and therefore a potential for successful receipt of a subsequent signal is improving, the electronic device 10 may increase the transmission power used to re-transmit the subsequent signal by a relatively lower amount to limit transmission power while still enabling receipt of the subsequent signal by the communication node 102. In response to determining that the elevation angle 108 is decreasing over time and therefore a potential for successful receipt of a subsequent signal is decreasing, the electronic device 10 may increase the transmission power used to re-transmit the subsequent signal by a relatively higher amount (e.g., compared to the relatively lower amount) to facilitate receipt of the subsequent signal by the communication node 102.

As such, the electronic device 10 may re-transmit a subsequent signal by an adjusted transmission power that may be more suitable based on the relative movement between the communication node 102 and the electronic device 10. For example, the communication node 102 may be able to receive the subsequent signal transmitted at the adjusted transmission power that is increased by the relatively lower amount during an increasing angle trend, because the communication quality between the electronic device 10 and the communication node 102 may have improved (e.g., the line of sight 112 between the electronic device 10 and the communication node 102 may become less obstructed). Additionally, the communication node 102 may be able to receive the subsequent signal transmitted at the adjusted transmission power that is increased by the relatively higher amount during a decreasing angle trend, because the relatively higher increase of the transmission power may offset and compensate for the potentially decreasing communication quality between the electronic device 10 and the communication node 102.

In certain embodiments, the electronic device 10 may store information associated with a successful signal transmission to the communication node 102. By way of example, in response to determining the communication node 102 successfully receives a signal transmitted by the electronic device 10, the electronic device 10 may store the elevation angle 108, the transmission power, and/or other information associated with the successful signal transmission. The electronic device 10 may then transmit a subsequent signal based on the stored information to facilitate successful receipt of the subsequent signal. By way of example, the electronic device 10 may block transmission of the subsequent signal until the elevation angle 108 between the communication node 102 and the electronic device 10 has reached or exceeded the stored elevation angle 108 associated with a previous successful signal transmission. Additionally or alternatively, the electronic device 10 may transmit the subsequent signal at the stored transmission power associated with a previous successful signal transmission. In this manner, the electronic device 10 may utilize previous information to adjust subsequent signal transmission to emulate a previous successful signal transmission condition and improve potential for successful signal receipt at the communication node 102 (e.g., reduce a number of transmitted signals that are not successfully received by the communication node 102).

The electronic device 10 may additionally or alternatively block subsequent signal transmission to the communication node 102 altogether in some embodiments. As an example, the electronic device 10 may determine that the elevation angle 108 is decreasing over time and a duration of time associated with attempted signal transmission or re-transmission to the communication node 102 is above a threshold duration. Such circumstances may indicate that the communication node 102 may not successfully receive subsequent signals. Thus, in response, the electronic device 10 may block subsequent signal transmission to the communication node 102 to reduce expending resources used to transmit a signal that may have reduced (e.g., decreasing) potential of being received by the communication node 102.

The electronic device 10 may also adjust operations to establish a communication link with the communication node 102 more quickly, such as to communicate an intended signal (e.g., an emergency message) to a target recipient and limit heating and/or power consumption associated with the electronic device 10. For example, the electronic device 10 may perform an abbreviated data transmission operation, which may include fewer initial signal or data exchanges with the communication node 102 for enabling (e.g., authorizing) the electronic device 10 to transmit an intended signal. The relatively fewer initial signal exchanges may reduce heating of and/or power consumption by the electronic device 10 to transmit the signal to the target recipient. Thus, operation of the electronic device 10 to transmit the signal may be more efficient and/or desirable in certain circumstances.

In further embodiments, the electronic device 10 may adjust a signal transmission rate (e.g., a quantity of attempted signal transmissions over a period of time) based on various parameters. By way of example, the processor 12 may determine a priority of a signal, a communication quality between the electronic device 10 and the communication node 102, and/or the elevation angle 108. The processor 12 may cause the transceiver 30 to re-transmit a signal (e.g., based on unsuccessful receipt of the signal by the communication node 102) at a particular rate based on such parameters. For example, in response to determining that the parameters indicate the signal may be more desirably and/or readily received by the communication node 102 (e.g., the signal is of high priority, the communication quality between the electronic device 10 and the communication node 102 is high, the elevation angle 108 is high), the electronic device 10 may transmit the signal at an increased rate. However, the electronic device 10 may transmit the signal at a reduced rate in response to determining that the parameters indicate the signal is not desirably and/or readily received by the communication node 102 (e.g., the signal is of low priority, the communication quality between the electronic device 10 and the communication node 102 is low, the elevation angle 108 is low). The electronic device 10 may also transmit the signal at an intermediate rate based on the parameters. In this manner, the operation of the electronic device 10 to transmit the signal may be more suitable to avoid excess resource expenditure to transmit a signal to the communication node 102.

The electronic device 10 may further adjust signal transmission based on other parameters, such as a position of the electronic device 10 with respect to a beam associated with the communication node 102, an error rate of data transmission, and/or an embodiment (e.g., a generation) of the communication node 102. Indeed, the electronic device 10 may adjust the transmission power and/or the transmission rate based on such parameters, such as in addition to or as an alternative to the other parameters described above, to transmit a signal in a more suitable manner to the communication node 102. For example, such adjustment of the transmission power and/or of the transmission rate may enable the electronic device 10 to transmit the signal to the communication node 102 while limiting resource expenditure.

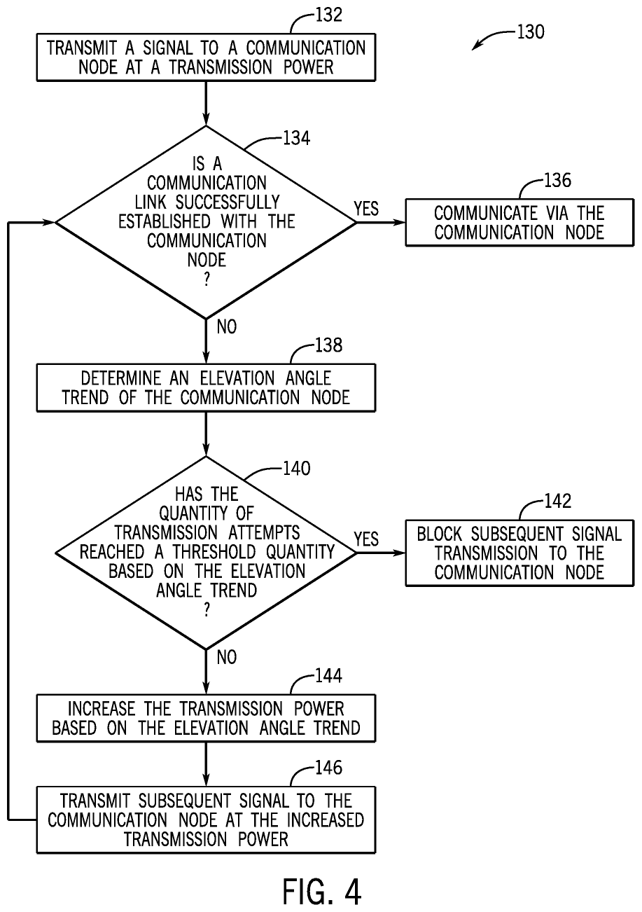

Each of FIGS. 4-9 described below illustrates a respective method for communicating signals. Any suitable device, such as the processor 12, that may control components of the electronic device 10 may perform the methods. In some embodiments, each of the methods may be implemented by executing instructions stored in a tangible, non-transitory, computer-readable medium, such as the memory 14 or storage 16, using the processor 12. For example, the methods may be performed at least in part by one or more software components, such as an operating system of the electronic device 10, one or more software applications of the electronic device 10, and the like. While each of the methods is described using steps in a specific sequence, additional steps may be performed, the described steps may be performed in different sequences than the sequence illustrated, and/or certain described steps may be skipped or not performed altogether. Further still, the steps of any of the respective methods may be performed in parallel with one another, such as at the same time, and/or in response to one another. Moreover, while the methods of FIGS. 4-9 are described with respect to communication between the electronic device 10 and the communication node 102, the techniques described herein may be implemented for communication between the electronic device 10 and any other recipient, such as the entity 104.

FIG. 4 is a flowchart of a method 130 for adjusting transmission power used to re-transmit a signal. At block 132, the electronic device 10 may transmit a signal (e.g., a preamble) directed to a communication node (e.g., the communication node 102) at an initial transmission power to attempt to establish a communication link with the communication node. In some embodiments, the initial transmission power of the signal may be based on a detected parameter, such as an elevation angle of the communication node, a received signal strength, a received signal quality, and so forth. In additional or alternative embodiments, the initial transmission power may be a predetermined value and may not change based on other parameters.

At block 134, the electronic device 10 determines whether a communication link is successfully established with the communication node (e.g., via a RACH). For example, the electronic device 10 may determine whether an acknowledgement signal is received from the communication node within a threshold duration of time since transmission of the signal to the communication node. At block 136, in response to determining successful establishment of the communication link with the communication node, the electronic device 10 may communicate via the communication node. For instance, the electronic device 10 may transmit a subsequent signal to the communication node for the communication node to forward to a recipient. Additionally or alternatively, the electronic device 10 may receive a subsequent signal from the communication node, such as a signal initially transmitted by another entity to the communication node for subsequent forwarding to the electronic device 10.

However, in response to determining unsuccessful establishment of the communication link with the communication node, the electronic device 10 may determine whether to re-transmit the signal for another attempt to establish the communication link with the communication node. As an example, at block 138, the electronic device 10 may determine an elevation angle trend of the communication node. That is, the electronic device 10 may determine whether the elevation angle is increasing (e.g., includes a rising edge) over time or is decreasing (e.g., includes a falling edge) over time, such as via stored data (e.g., TLE data, ephemeris data) and/or via sensor data. At block 140, the electronic device 10 may determine whether a quantity of attempts to transmit or re-transmit a signal to establish the communication link has reached a threshold quantity that is based on the elevation angle trend. For instance, the threshold quantity may include a quantity between 3-5 attempts, 5-10 attempts, or more than 10 attempts for a decreasing elevation angle. The threshold quantity may be relatively higher for an increasing elevation angle, such as more than 10 attempts.

At block 142, in response to determining that the quantity of attempts to transmit or re-transmit the signal has exceeded the threshold quantity, the electronic device may block subsequent signal transmission to the communication node. Blocking subsequent signal transmission may block additional resource usage (e.g., power consumption, transmission power budget usage) by the electronic device 10. For example, for a communication node having an elevation angle that is decreasing over time to cause a decreasing communication quality between the electronic device 10 and the communication node, a potential for successful receipt of a subsequent signal by the communication node may decrease. Thus, the electronic device 10 may block subsequent signal transmission after the threshold quantity of attempts have been reached to avoid continual resource expenditure to establish a communication link with a communication node associated with a decreasing potential for successful signal receipt. However, for a communication node having an elevation angle that is increasing over time to cause an increasing communication quality between the electronic device 10 and the communication node, effective potential for successful receipt of a subsequent signal by the communication node may increase. Thus, the threshold quantity of attempts associated with the increasing elevation angle may be greater than the threshold quantity of attempts associated with the decreasing elevation angle to enable more signal transmissions for the increasing elevation angle.

At block 144, in response to determining that the quantity of attempts to transmit or re-transmit the signal has not exceeded the threshold quantity, the electronic device 10 may increase the transmission power based on the elevation angle trend to prepare to re-transmit the signal. As an example, the electronic device 10 may increase the transmission power by a first value (e.g., a value less than 1 decibel (dB) a value between 1 and 3 dB, a value between 2 and 4 dB, a value more than 4 dB) for an increasing elevation angle, and the electronic device 10 may increase the transmission power by a second value (e.g., a value between 1 and 3 dB, a value between 2 and 4 dB, a value between 3 and 5 dB, a value more than 5 dB) for a decreasing elevation angle. In some embodiments, the second value may be greater than the first value to improve potential for successful establishment of the communication link in the subsequent attempt. For instance, the decreasing elevation angle may cause reduced communication quality between the electronic device 10 and the communication node. Therefore, the electronic device 10 may increase the transmission power by a greater value for the decreasing elevation angle to compensate for the reducing communication quality. At block 146, the electronic device 10 may transmit a subsequent signal directed to the communication node at the increased transmission power to attempt to establish the communication link with the communication node again.

The electronic device 10 may iteratively or repeatedly perform the method 130. For example, the electronic device 10 may continue to increase the transmission power of the signal and then attempt to transmit the signal directed to the communication node until a communication link is successfully established with the communication node and/or the threshold quantity of attempts have been reached. In this manner, the electronic device 10 may complete performance of the method 130 by communicating via the communication node with a successfully established communication link or by blocking additional signal transmission to the communication node to avoid further expenditure of resources related to establishing the communication link with the communication node. The electronic device 10 may also perform the method 130 for multiple communication nodes. For example, after the electronic device 10 blocks signal transmission to a first communication node (e.g., in response to the quantity of signal transmission attempts with the first communication node reaching the threshold quantity of attempts), the electronic device 10 may perform the method 130 with respect to a second communication node to attempt to establish a communication link with the second communication node. As such, the electronic device 10 may repeatedly perform the method 130 with different communication nodes until a communication link is successfully established with a communication node.

In certain embodiments, the electronic device 10 may avoid transmitting the signal at a transmission power above a threshold transmission power. As an example, after determining an unsuccessful establishment of a communication link via a signal transmitted at the threshold transmission power, the electronic device 10 may re-transmit a subsequent signal at the threshold transmission power again instead of at a transmission power greater than the threshold transmission power. As another example, the electronic device 10 may re-transmit the subsequent signal at a reduced transmission power, such as at the initial transmission power used at block 132. In this way, the electronic device 10 may cyclically increase the transmission power to the threshold transmission power and restart the transmission power at the initial transmission power when the threshold transmission power is reached. For instance, for a communication node in which the elevation angle is increasing, the electronic device 10 may restart the transmission power after every 5 attempted signal transmissions, after every 10 attempted signal transmissions, after more than 10 attempted signal transmissions, and so forth.

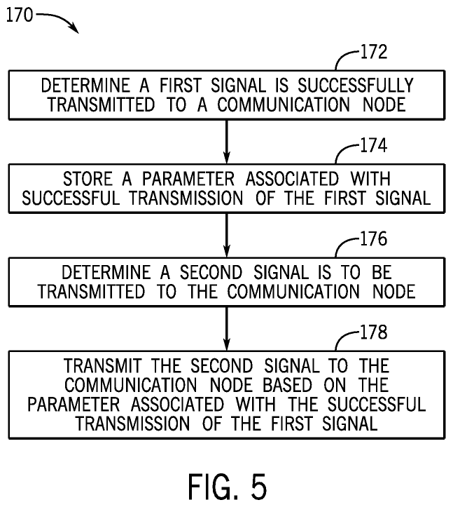

FIG. 5 is a flowchart of a method 170 for transmitting a signal to a communication node based on an elevation angle trend. For example, the method 170 may be performed to increase a likelihood of re-transmission of a signal. At block 172, the electronic device 10 may determine successful transmission of a first signal to a communication node (e.g., to establish a communication link, such as via a RACH, with the communication node), such as by performing the method 130. For example, the electronic device 10 may determine successful transmission of the first signal to the communication node in response to receiving an acknowledgement signal from the communication node.

At block 174, the electronic device 10 may store a parameter associated with the successful transmission of the first signal to the communication node. For instance, the parameter may include an elevation angle, a transmission power, a received signal strength, a received signal quality, a rate of signal transmission, and the like. At block 176, the electronic device 10 may determine a second signal is to be transmitted to the communication node and/or to a different communication node (e.g., to establish another communication link). For example, the electronic device 10 may receive an indication that the second signal is to be transmitted to the communication node and/or to the different communication node.

At block 178, in response to determining the second signal is to be transmitted to the communication node, the electronic device 10 may transmit the second signal to the communication node based on the parameter associated with the successful transmission of the first signal to the communication node. As an example, the stored parameter may indicate that the first signal was successfully transmitted at a particular elevation angle of the communication node. Thus, the electronic device 10 may begin to transmit the second signal in response to determining a current elevation angle of the communication node is at least the particular elevation angle. That is, the electronic device 10 may block transmission of the second signal until the current elevation angle is at or above the particular elevation angle. As another example, the stored parameter may indicate the first signal was successfully transmitted at a particular transmission power. As such, the electronic device 10 may initially transmit the second signal at the particular transmission power. Indeed, the electronic device 10 may transmit the second signal using the stored parameter associated with the successful transmission of the first signal to emulate conditions of a previously successful signal transmission. In this manner, the electronic device 10 may improve potential of successful transmission of the second signal, such as without expending resources related to re-transmitting the second signal multiple times before successful receipt by the communication node.

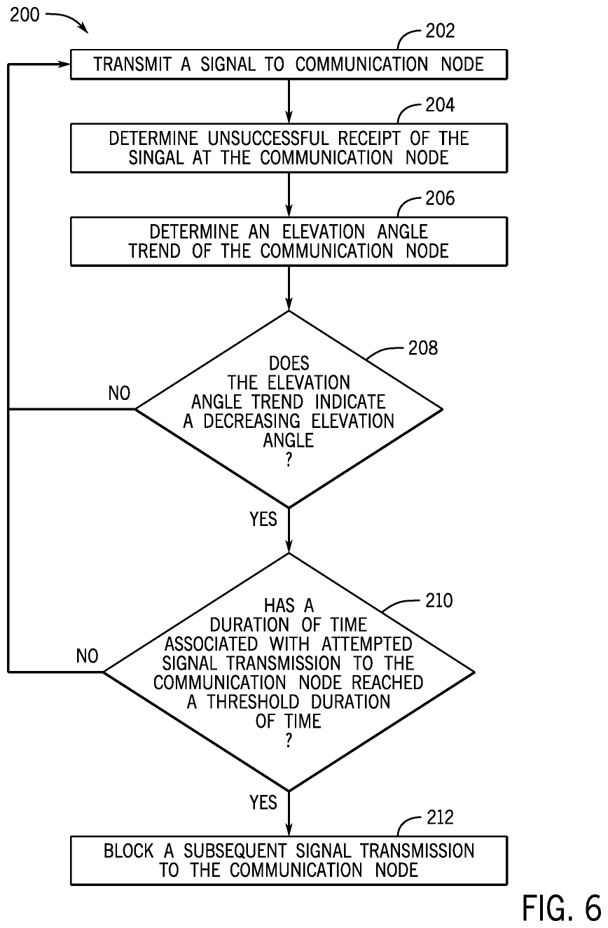

FIG. 6 is a flowchart of a method 200 for adjusting signal transmission to a communication node based on an elevation angle trend. The method 170 may be performed to determine whether a signal is to be re-transmitted to a communication node. At block 202, the electronic device 10 may transmit a signal (e.g., a preamble) directed to a communication node (e.g., to establish a communication link, such as via a RACH, with the communication node). At block 204, the electronic device 10 may determine the signal is not successfully received at the communication node. By way of example, the electronic device 10 may determine that an acknowledgement signal is not received from the communication node 102 to indicate successful receipt of the signal.

At block 206, the electronic device 10 may determine an elevation angle trend of the communication node, such as via stored data and/or sensor data, and determine whether the elevation angle is increasing or decreasing over time. At block 208, the electronic device 10 may determine whether the elevation angle trend indicates a decreasing elevation angle. In response to determining that the elevation angle trend does not indicate a decreasing elevation angle (e.g., the elevation angle is increasing over time, the elevation angle is constant over time), the electronic device 10 may repeat the operation at block 202 to re-transmit the signal. In some embodiments, the electronic device 10 may increase the transmission power of the signal for re-transmission to improve potential of successful receipt of the signal at the communication node.

At block 210, the electronic device 10 may determine whether a duration of time associated with attempted signal transmission or re-transmission to the communication node has reached a threshold duration of time. In other words, the electronic device 10 may determine whether the signal has been successfully received at the communication node within the threshold duration of time. In response to determining that the duration of time associated with attempted signal transmission or re-transmission to the communication node has not reached the threshold duration of time, the electronic device 10 may repeat the operation at block 202 to re-transmit the signal (e.g., at an increased transmission power). However, at block 212, in response to determining that the duration of time associated with attempted signal transmission or re-transmission to the communication node has reached the threshold duration of time, the electronic device 10 may block a subsequent signal transmission to the communication node. That is, for an increasing or constant elevation angle, the electronic device 10 may repeatedly re-transmit a signal to the communication node until the communication node successfully receives the signal. However, for a decreasing elevation angle, the electronic device 10 may re-transmit a signal until the communication node successfully receives the signal or the threshold duration of time has elapsed, because the communication quality, and therefore potential of successful signal receipt, associated with subsequent transmission of the signal may be worsening. As such, the electronic device 10 may avoid expending additional resources related to signal transmission to the communication node.

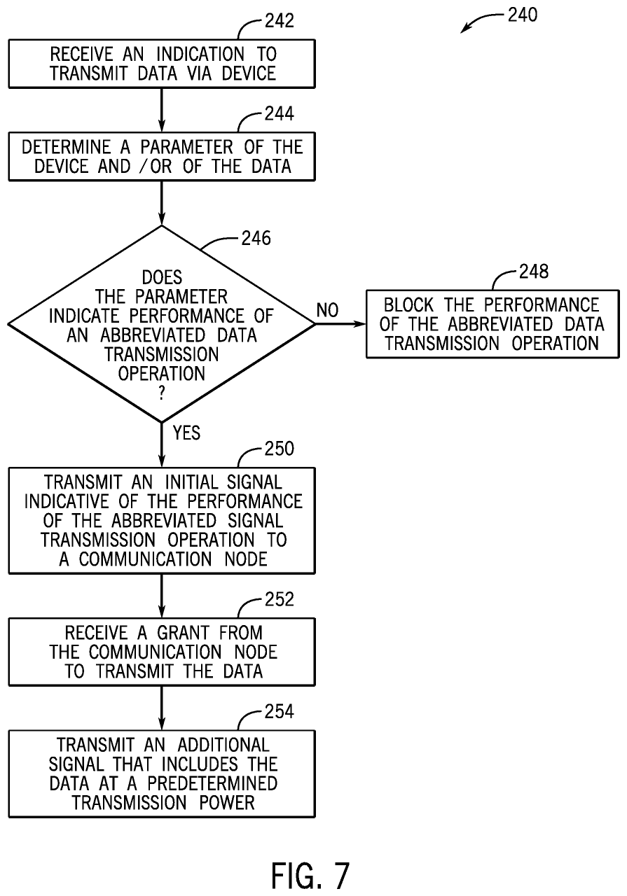

FIG. 7 is a flowchart of an embodiment of a method 240 for operating to transmit a signal to a communication node, such as to perform an abbreviated data transmission operation to transmit a signal more readily. At block 242, the electronic device 10 may receive an indication to transmit data to the communication node. As an example, the electronic device 10 may receive a user input associated with a request to transmit the data to the communication node. As another example, the electronic device 10 may automatically transmit the data (e.g., without an additional user input), such as based on a scheduled time interval, in response to receipt of another input, and so forth.

At block 244, in response to receiving the indication, the electronic device 10 may determine a parameter of the electronic device 10 and/or of the data. For instance, the parameter may indicate a thermal state of the electronic device 10 (e.g., based on a temperature of the electronic device 10), a power level (e.g., a remaining battery charge) of the electronic device 10, a priority of the data, a transmission power, and the like. At block 246, the electronic device 10 may determine whether the parameter indicates performance of an abbreviated data transmission operation. By way of example, performance of the abbreviated data transmission operation may be desirable based on a determination that the electronic device 10 is thermally limited (e.g., a temperature of the electronic device 10 is at a threshold temperature), the power level is less than a threshold level (e.g., a percentage between 15%-25%, between 5% and 15%, less than 5%), and/or the priority of the data is urgent (e.g., the data includes an emergency message).

At block 248, the electronic device 10 may block performance of the abbreviated data transmission operation in response to determining that the parameter does not indicate performance of the abbreviated data transmission operation, such as in response to determining that the electronic device 10 is not thermally limited, the power level is not less than the threshold level (e.g., the power level is above the threshold level, the power level is at the threshold level), and/or the priority of the data is not urgent. Instead, the electronic device 10 may not transmit the data to the communication node, for example (e.g., until the electronic device 10 is no longer thermally limited, until the power level of the electronic device 10 is above the threshold level). Additionally or alternatively, the electronic device 10 may perform a standard (e.g., non-abbreviated) data transmission operation. For example, the standard data transmission operation may include several initial exchanges of data between the electronic device 10 and the communication node, such as an initial access request transmitted by the electronic device 10, an access response transmitted by the communication node, a scheduling request transmitted by the electronic device 10, and a grant transmitted by the communication node, before the electronic device 10 is able to (e.g., authorized to) transmit the data to the communication node.

However, in response to determining that the parameter indicates performance of the abbreviated data transmission operation, the electronic device 10 may prepare to perform the abbreviated data transmission operation. For instance, at block 250, the electronic device may transmit an initial signal (e.g., a preamble, a payload) indicative of performance of the abbreviated data transmission operation to the communication node. In some embodiments, the electronic device 10 may transmit the initial signal via a communication link (e.g., a physical uplink shared channel that carries data of the electronic device 10) previously established between the electronic device 10 and the communication node. The initial signal may include the information regarding the determined parameter (e.g., the thermal state, the power level, the data priority, the transmission power) to indicate the performance of the abbreviated data transmission operation.

At block 252, the electronic device 10 may receive a grant (e.g., an uplink grant) from the communication node to transmit the data after transmitting the initial signal to the communication node. The grant may enable or authorize the electronic device 10 to transmit the data to the communication node. That is, the communication node may assign the grant to the electronic device 10, and the electronic device 10 may therefore be able to transmit the data, without the electronic device 10 having to transmit additional signals after the initial signals. For instance, the electronic device 10 may be able to transmit the data to the communication node without transmitting a scheduling request to the communication node.

At block 254, upon receiving the grant from the communication node, the electronic device 10 may transmit an additional signal that includes the data at a predetermined transmission power to the communication node. As an example, the electronic device 10 may transmit the additional signal at a transmission power (e.g., an upper limit transmission power) that may not otherwise be enabled without performance of the abbreviated data transmission operation (e.g., as limited by the thermal state of the electronic device 10). The transmission power of the additional signal may facilitate potential for successful receipt of the data at the communication node, such as to reduce having to re-transmit a subsequent signal that includes the data as a result of unsuccessful receipt of the additional signal at the communication node. Additionally, performance of the abbreviated data transmission operation may enable the electronic device 10 to transmit the additional signal at reduced latency and/or without transmitting additional signals (e.g., for radio resource control for establishing a communication link, for a scheduling request to enable data transmission) to avoid operations that may further increase thermal load and/or reduce the power level of the electronic device 10. As such, the abbreviated data transmission operation may enable the electronic device 10 to transmit the additional signal more readily.

The electronic device 10 may be able to repeat performance of the method 240. For example, the electronic device 10 may determine whether the communication node successfully receives the additional signal having the data, and the electronic device 10 may perform the method 240 to re-transmit a subsequent signal having the data in response to determination of unsuccessful receipt of the additional signal. Additionally or alternatively, the electronic device 10 may receive an indication to transmit different data and may perform the method 240 to transmit a subsequent signal that includes such data. In certain embodiments, the electronic device 10 may transmit signals at a certain rate (e.g., at a reduced rate) via performance of the method 240 to provide a period of time in which the electronic device 10 may avoid transmitting signals. As a result, the electronic device 10 may reduce the thermal load of the electronic device 10 and/or avoid over usage of power.

In some embodiments, the communication node may also adjust operation to facilitate further signal transmission from the electronic device 10 (e.g., while the electronic device 10 is thermally limited, while the electronic device 10 has a low power level, while the data being transmitted is of high priority), such as re-transmission of the signal that includes the data in response to determining unsuccessful receipt of a previously transmitted signal by the communication node. As an example, the communication node may provide semi persistent scheduling that enables the electronic device 10 to re-transmit a signal that includes the data at particular time intervals without having to re-perform certain operations. For instance, the electronic device 10 may avoid transmitting a request (e.g., a scheduling request), the initial signal indicative of the performance of the abbreviated data transmission operation, and/or any other suitable signal prior to transmitting a signal that includes the data. Thus, latency, computing power, resource allocation, and/or other operational workload associated with re-transmitting signals having the data may be further reduced. As another example, the communication node may assign a dedicated communication link (e.g., a physical random access channel) to the electronic device 10 for usage. The dedicated communication link, such as a communication link having a particular frequency bandwidth, may enable the electronic device 10 or any other electronic device to transmit a signal (e.g., via the abbreviated data transmission operation) with limited interference and/or contention from other electronic devices transmitting signals to the communication node (e.g., via a non-abbreviated data transmission operation).

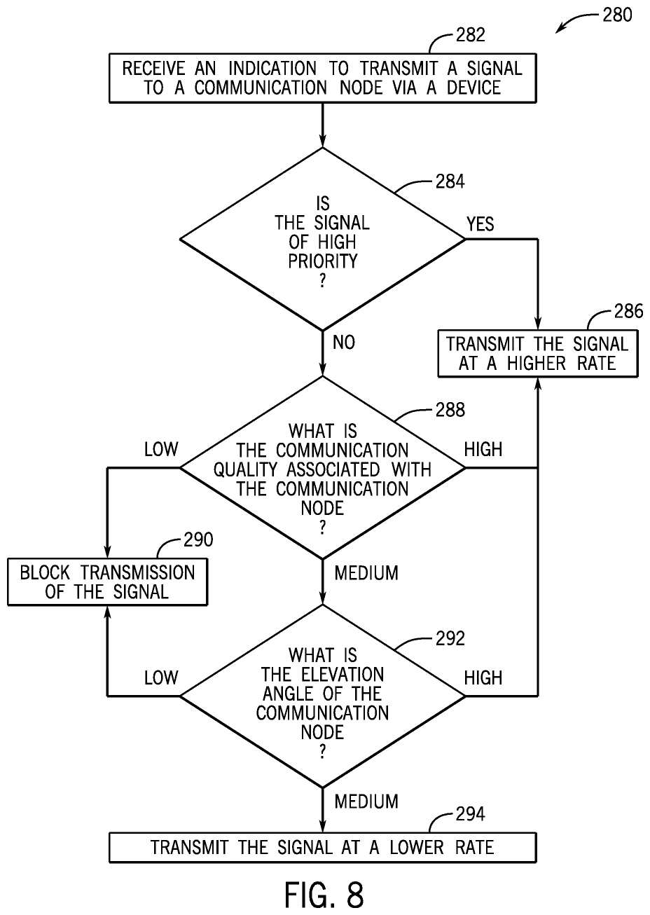

FIG. 8 is a flowchart of a method 280 for adjusting a rate of transmission of a signal to transmit the signal more suitably (e.g., limit resource usage while still providing desirable likelihood of successful receipt of the signal). At block 282, the electronic device 10 may receive an indication to transmit a signal to a communication node. For example, the signal may include data to be relayed by the communication node to a recipient. In response, the electronic device 10 may determine various parameters to determine a rate in which the signal may be transmitted to the communication node, such as for re-transmission of the signal in response to determining unsuccessful receipt of the signal at the communication node.

At block 284, the electronic device 10 may determine whether the signal and/or the data included in the signal is of high priority. At block 286, in response to determining the signal and/or the data is of high priority, the electronic device 10 may transmit the signal at a higher rate. For example, there may be various time intervals in which the electronic device 10 is able or scheduled to transmit a signal, and the electronic device 10 may transmit the signal at each available time interval in response to determining the signal and/or the data is of high priority to attempt to transmit the signal to the communication node. As such, the electronic device 10 may increase the rate of attempts to transmit the signal and increase potential for successful receipt at the communication node.

However, in response to determining that the signal and/or the data is not of high priority, the electronic device 10 may determine a communication quality associated with the communication node, as shown at block 288. The communication quality may include a signal to noise ratio, a received signal strength, a received signal quality, and/or any other suitable parameter. In response to determining the communication quality is high (e.g., the signal to noise ratio is greater than a high threshold value, which may be a value between −1 dB and −5 dB, a value between −4 dB and −8 dB, a value between −7 dB and −12 dB), the electronic device 10 may transmit the signal at the higher rate, as shown at block 286. That is, the electronic device 10 may increase the rate of signal transmission to attempt to achieve the successful receipt based on the communication quality indicating a relatively higher potential of successful receipt of the signal at the communication node. However, in response to determining the communication quality is low (e.g., the signal to noise ratio is less than a low threshold value, which may be a value between −10 dB and −20 dB, a value between −15 dB and −30 dB, a value below −30 dB), the electronic device 10 may block transmission of the signal, as shown at block 290. For instance, the low communication quality and the relatively lower priority may indicate that operation to transmit a signal successfully to the communication node may undesirably expend resources (e.g., power consumption, transmission power budget usage).

In response to determining the communication quality is medium or within a medium range (e.g., the signal to noise ratio is between the high threshold value and the low threshold value), the electronic device 10 may further determine the elevation angle of the communication node, as shown at block 292. In response to determining the elevation angle is high (e.g., the elevation angle is above a high threshold value, which may be a value between 20 degrees and 30 degrees, a value between 25 and 35 degrees, a value more than 35 degrees), thereby indicating a relatively higher potential of successful receipt of the signal at the communication node, the electronic device 10 may transmit the signal at the higher rate, as shown at block 286. However, in response to determining that the elevation angle is low (e.g., the elevation angle is below a low threshold value, which may be a value less than 10 degrees, a value between 5 degrees and 15 degrees, a value between 10 degrees and 20 degrees), thereby indicating a relatively lower potential of successful receipt of the signal at the communication node, the electronic device 10 may block transmission of the signal to avoid undesirably expending resources for transmitting the signal.

Furthermore, at block 294 in response to determining that the elevation angle is medium or within a medium range (e.g., the elevation angle is between the high threshold value and the low threshold value), the electronic device 10 may transmit the signal at a lower rate that is below a rate of transmitting the signal at the higher rate (e.g., as described at block 286). As an example, the electronic device 10 may transmit the signal at every other time interval in which the electronic device 10 is able or scheduled to transmit a signal. In this way, the electronic device 10 may alternate between cycles of transmitting the signal and not transmitting the signal. For instance, the electronic device 10 may attempt to transmit the signal without expending as many resources in comparison to transmitting the signal at the higher rate.

In some embodiments, the electronic device 10 may repeatedly or iteratively perform the method 280. By way of example, the electronic device 10 may continually determine priority of the signal and/or of the data, the communication quality between the electronic device 10 and the communication node, and/or the elevation angle of the communication node. The electronic device 10 may then determine an updated rate in which the signal is to be transmitted. As an example, the electronic device 10 may dynamically determine an updated rate and adjust when a subsequent signal is transmitted in comparison to a previously transmitted signal. In this manner, the electronic device 10 may transmit the signal at a desirable rate that may be more suitable based on the parameters associated with the electronic device 10 and/or with the communication node.

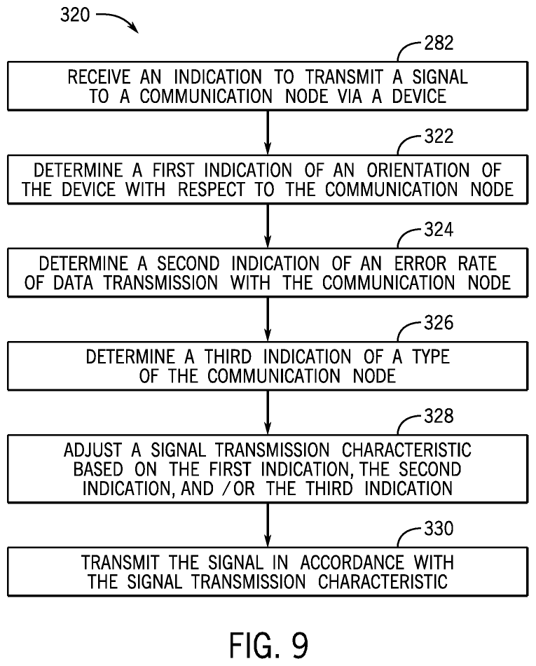

FIG. 9 is a flowchart of an embodiment of a method 320 for adjusting a transmission characteristic of a signal to transmit the signal more suitably. The electronic device 10 may begin performance of the method 320 by receiving an indication to transmit a signal to a communication node, as shown at block 282. At block 322, the electronic device 10 may determine a first indication of an orientation of the electronic device 10 with respect to the communication node. For example, the orientation of the electronic device 10 with respect to the communication node may include a position of the electronic device 10 with respect to a position of a beam emitted by the communication node, and the electronic device 10 may determine whether the electronic device 10 is positioned within the beam. The electronic device 10 may determine the position of the electronic device 10 with respect to the position of the beam based on stored data and/or sensor data. Positioning of the electronic device 10 within the beam of the communication node may increase potential receipt of a signal transmitted by the electronic device 10.

At block 324, the electronic device 10 may determine a second indication of an error rate of data transmission with the communication node. For instance, the error rate may include a block error rate (BLER) indicative of a ratio of a quantity of erroneous data blocks relative to a total quantity of data blocks being transmitted. The electronic device 10 and/or the communication node may determine the accuracy of each data block via a cyclic redundancy check, and the BLER may be indicative of a communication quality between the electronic device 10 and the communication node. As an example, a greater communication quality (e.g., reduced interference, greater signal to noise ratio) may result in lower error rate. Thus, a lower error rate may also indicate higher potential receipt of a signal transmitted by the electronic device 10, as well as more accurate receipt of data transmitted via the signal.

At block 326, the electronic device 10 may determine a third indication of type of the communication node. By way of example, the third indication may include a generation, a length of existence, a year of manufacture, a model, and the like of the communication node. For instance, newer embodiments of communication nodes may have relatively higher potential for receipt of a signal transmitted by the electronic device 10.

At block 328, the electronic device 10 may adjust a signal transmission characteristic based on the first indication, the second indication, and/or the third indication. As described above, positioning of the electronic device 10 within a beam of the communication node (e.g., as determined based on the first indication), reduced error rate (e.g., as determined based on the second indication), and/or new types of communication nodes (e.g., as determined based on the third indication) may indicate increased potential receipt of a signal transmitted by the electronic device 10. However, positioning of the electronic device 10 outside of a beam (e.g., the electronic device 10 is positioned in a null of intersection of the beam in which there is a lack of overlap between the electronic device 10 and the beam), an increased error rate (e.g., a BLER greater than a threshold rate, which may depend on data rate, such as a value between 20% and 30%, a value between 25% and 35%, a value between 30% and 40% for a data rate between 5 kilobits per second (kbps) to 30 kbps), and/or an older type (e.g., an earlier generation) of a communication node, may indicate reduced potential receipt of a signal transmitted by the electronic device 10. Based on such indications, the electronic device 10 may adjust the signal transmission characteristic to reduce resource expenditure associated with transmitting a signal to the communication node. For instance, the electronic device 10 may reduce the transmission power and/or reduce the rate of signal transmission. At block 330, the electronic device 10 may transmit the signal in accordance with the signal transmission characteristic. As such, the electronic device 10 may transmit the signal in a more suitable manner based on various determined parameters, such as by expending resources more suitably and/or enabling potential receipt of the signal more suitably.

Embodiments of the present disclosure are directed to operating an electronic device (e.g., a mobile communicating device) to communicate signals, such as to transmit and/or re-transmit a signal directed to a communication node for subsequent transmission to a target recipient. In some embodiments, the electronic device may monitor an elevation angle of the communication node to determine transmission power of a re-transmitted signal. For example, in response to determining the elevation angle is decreasing over time to indicate a communication quality between the electronic device and the communication node may be worsening, the electronic device may increase the transmission power by a higher value to compensate for a potentially reduced communication quality during re-transmission. In response to determining the elevation angle is increasing over time to indicate the communication quality may be improving, the electronic device may increase the transmission power by a lower value to reduce resource expenditure associated with re-transmitting the signal at a higher transmission power, while still enabling potential receipt of the signal by the communication node. In additional or alternative embodiments, the electronic device may determine a rate of transmission or re-transmission of a signal based on various parameters. Such parameters may include a priority of data included in the signal, a communication quality between the electronic device and the communication node, and/or an elevation angle of the communication node. By adjusting the manner in which the signal is transmitted and/or re-transmitted, the electronic device may operate more suitably to expend resources and/or enable successful receipt of the signal.

The specific embodiments described above have been shown by way of example, and it should be understood that these embodiments may be susceptible to various modifications and alternative forms. It should be further understood that the claims are not intended to be limited to the particular forms disclosed, but rather to cover all modifications, equivalents, and alternatives falling within the spirit and scope of this disclosure.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function] . . . ” or “step for [perform]ing [a function] . . . ”, it is intended that such elements are to be interpreted under 35 U.S.C. 112(f). However, for any claims containing elements designated in any other manner, it is intended that such elements are not to be interpreted under 35 U.S.C. 112(f).

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

What is claimed is:

1. An electronic device, comprising:
a transmitter; and
processing circuitry communicatively coupled to the transmitter and configured to
transmit a first signal directed to a communication node at a transmission power using the transmitter, and
transmit a second signal directed to the communication node at an increased transmission power using the transmitter based on a trend of a position of the communication node and based on unsuccessful receipt of the first signal by the communication node.

2. The electronic device of claim 1, wherein the position comprises an elevation angle of the communication node relative to the electronic device.

3. The electronic device of claim 2, wherein the processing circuitry is configured to
determine the increased transmission power by increasing the transmission power by a first value based on the trend of the elevation angle indicating an increasing elevation angle over time, and
determine the increased transmission power by increasing the transmission power by a second value based on the trend of the elevation angle indicating a decreasing elevation angle over time, wherein the second value is greater than the first value.

4. The electronic device of claim 2, wherein the processing circuitry is configured to
transmit the second signal directed to the communication node at the increased transmission power using the transmitter based on the trend of the elevation angle of the communication node relative to the electronic device, based on the unsuccessful receipt of the first signal by the communication node, and based on a quantity of attempts of signal transmission to the communication node being less than a threshold quantity, the threshold quantity being based on the trend of the elevation angle of the communication node relative to the electronic device, and
block transmission of the second signal directed to the communication node based on the quantity of attempts of signal transmission to the communication node being at or above the threshold quantity.

5. The electronic device of claim 1, wherein the processing circuitry is configured to
store a parameter associated with successful signal transmission based on successful receipt of the first signal, successful receipt of the second signal, or both by the communication node, and
transmit a third signal directed to the communication node using the transmitter based on the parameter.

6. The electronic device of claim 5, wherein the parameter comprises an initial elevation angle of the communication node, and the processing circuitry is configured to transmit the third signal using the transmitter based on an updated elevation angle of the communication node being at or above the initial elevation angle.

7. The electronic device of claim 5, wherein the parameter comprises the transmission power at which the first signal is transmitted, the increased transmission power at which the second signal is transmitted, or both, and the processing circuitry is configured to transmit the third signal at the transmission power or the increased transmission power using the transmitter.

8. A non-transitory computer-readable medium, comprising instructions that, when executed by processing circuitry, are configured to cause the processing circuitry to:
transmit a first signal directed to a communication node at a first transmission power using a transmitter of an electronic device;
establish a communication link with the communication node based on successful receipt of the first signal; and
transmit a second signal directed to the communication node at a second transmission power using the transmitter based on unsuccessful receipt of the first signal by the communication node, wherein the second transmission power is based on a trend of an elevation angle of the communication node with respect to the electronic device.

9. The non-transitory computer-readable medium of claim 8, wherein the instructions, when executed by the processing circuitry, are configured to cause the processing circuitry to:
receive the second transmission power by increasing the first transmission power by a first power value based on the elevation angle increasing over time; and
receive the second transmission power by increasing the first transmission power by a second power value based on the elevation angle decreasing over time, the second power value being greater than the first power value.

10. The non-transitory computer-readable medium of claim 8, wherein the instructions, when executed by the processing circuitry, are configured to cause the processing circuitry to:
determine a duration of time associated with attempted signal transmission to the communication node based on the elevation angle decreasing over time; and
transmit the second signal directed to the communication node using the transmitter based on the unsuccessful receipt of the first signal and based on the duration of time being less than a threshold duration of time.

11. The non-transitory computer-readable medium of claim 10, wherein the instructions, when executed by the processing circuitry, are configured to cause the processing circuitry to block transmission of the second signal directed to the communication node based on the duration of time being at or above the threshold duration of time.

12. The non-transitory computer-readable medium of claim 8, wherein the instructions, when executed by the processing circuitry, are configured to cause the processing circuitry to:
receive an indication to transmit data to the communication node;
transmit a third signal directed to the communication node using the transmitter based on the indication, the third signal indicating performance of an abbreviated data transmission operation;
receive a grant from the communication node to transmit the data based on the third signal; and
transmit a fourth signal directed to the communication node at a predetermined transmission power using the transmitter based on the grant, the fourth signal comprising the data.

13. The non-transitory computer-readable medium of claim 12, wherein the instructions, when executed by the processing circuitry, are configured to cause the processing circuitry to transmit the third signal directed to the communication node using the transmitter based on the indication and based on a priority of the data, a power level of the electronic device, a thermal state of the electronic device indicating the electronic device is thermally limited, or any combination thereof.

14. The non-transitory computer-readable medium of claim 8, wherein the instructions, when executed by the processing circuitry, are configured to cause the processing circuitry to transmit the first signal and the second signal directed to the communication node using the transmitter at a rate based on a priority, a communication quality between the electronic device and the communication node, the elevation angle of the communication node with respect to the electronic device, or any combination thereof.

15. A method, comprising:
determining, via processing circuitry of an electronic device, a first indication of a priority of a signal, a second indication of a communication quality between the electronic device and a communication node, and a third indication of an elevation angle of the communication node; and
transmitting, via the processing circuitry, the signal directed to the communication node at a rate using a transmitter of the electronic device based on the first indication, the second indication, and the third indication.

16. The method of claim 15, comprising transmitting, via the processing circuitry, the signal directed to the communication node at a first rate using the transmitter based on the priority of the signal being a high priority, the communication quality between the electronic device and the communication node being high, the elevation angle of the communication node being high, or any combination thereof.

17. The method of claim 16, comprising transmitting, via the processing circuitry, the signal directed to the communication node at a second rate using the transmitter based on the priority of the signal being a lower priority, the communication quality between the electronic device and the communication node being low, the elevation angle of the communication node being low, or any combination thereof, wherein the second rate is lower than the first rate.

18. The method of claim 17, comprising transmitting, via the processing circuitry, the signal at a third rate using the transmitter based on the priority of the signal being the lower priority, the communication quality between the electronic device and the communication node being between low and high, and the elevation angle of the communication node being between low or high, wherein the third rate is between the first rate and the second rate.

19. The method of claim 16, comprising:
transmitting, via the processing circuitry, the signal using the transmitter at the first rate based on the priority of the signal being the high priority; and
determining, via the processing circuitry, the second indication of the communication quality between the electronic device and the communication node, the third indication of the elevation angle of the communication node, or both based on the priority of the signal being a lower priority.

20. The method of claim 15, comprising:
determining, via the processing circuitry, a fourth indication of a position of the electronic device with respect to a beam of the communication node, a fifth indication of an error rate of data transmission with the communication node, and a sixth indication of an embodiment of the communication node; and
adjusting, via the processing circuitry, the rate at which the signal is transmitted, a transmission power at which the signal is transmitted, or both based on the fourth indication, and the fifth indication, the sixth indication.
